(19) United States
(12) Patent Application Publication
(10) Pub. No.: US 2010/0034418 A1
(43) Pub. Date: Feb. 11, 2010

(54) HIGH PERFORMANCE MICRO SPEAKER

(75) Inventor: Wayne Allen Bonin, North Oaks, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/189,412

(22) Filed: Aug. 11, 2008

(51) Int. Cl. H04R 11/02; H04R 1/00

(52) U.S. Cl. 381/396; 381/398; 381/412

(57) ABSTRACT

A micro speaker having a first core assembly and a second core assembly, with a diaphragm between the first and second core assemblies. Each of the core assemblies includes a housing with a pole and a cover plate, and a permanent magnet within the housing. At least one of the core assemblies includes an electrically conductive coil positioned around the pole. Each of the cover plates has a groove therein. The micro speaker further includes a soft magnetic armature present between each cover plate and the diaphragm, with a portion of each armature present and moveable within the grooves.

### BACKGROUND

Speakers are acoustical elements that are common is today's society. Speakers are present in radios, stereo systems, televisions, computers, earphones/headphones and other personal equipment that is configured to emit sound. Without speakers, one could not enjoy music, a television program, or a movie, to its full extent.

A traditional speaker (also referred to as a loud speaker or variation thereof) has a large magnet in close proximity to a movable current coil which drives a cone/diaphragm. The oscillating cone/diaphragm generates sound. A single loud speaker, however, typically does not have sufficient frequency bandwidth to amplify an audio signal at the full bandwidth. To expand the overall bandwidth of a speaker system, a multi-speaker system is compiled where each speaker is responsible for a limited bandwidth range. This type of system consumes a large amount of power, occupies larger space and is expensive. This issue also exists in headphones or earphones products.

Attempts have been made to miniaturize speakers using micro-system technology (MST). Although low cost and good reproducibility of electronic circuitry has been obtained, the number of realized loudspeakers using MST is small and these loudspeakers generally do not fulfill the requirements for a hearing instrument such as hearing aids.

Hearing aids require very small, high output micro speakers with dimensions of just a few millimeters. Because of the close proximity of the speaker and receiver, the micro speaker typically needs to include a sealed back chamber so that the sound is directed only into the ear canal, and not to the outside, where it would generate feedback problems with the receiver. Due to the small volume of the back chamber (restricted by the overall size of the device), the pressure in the back chamber may be 100 times that required for the output into the ear canal, increasing the required force of the speaker actuator by the same factor. Current micro speaker devices typically have a resonant peak at about 4000 Hz, which enables them to produce a high pressure output at that frequency, but the maximum output power drops off drastically above and below the resonant frequency. Current designs are also not favorable for batch type assembly operations, resulting in high cost for a poor audio quality component. Improved micro speakers are needed.

### BRIEF SUMMARY

The present disclosure is directed to high performance micro speakers, suitable for use in hearing aids, headphones and other small applications. The speakers have a first core assembly and a second core assembly, with a diaphragm between the core assemblies. Each of the core assemblies includes a housing and a cover plate, and a permanent magnet. The speakers include a soft magnetic armature present on each side of the diaphragm, the armatures moveably present within a groove and in relation to a permanent magnet. At least one of the manufacturing steps of the micro speaker can be performed at a semiconductor wafer level.

In one exemplary embodiment, this disclosure provides a micro speaker having a first core assembly and a second core assembly, with a diaphragm between the first and second core assemblies. The first core assembly includes first housing and a first cover plate, a first permanent magnet within the first housing defining a first pole. The second core assembly includes a second housing and a second cover plate, and a second permanent magnet within the first housing defining a second pole. The first cover plate has a first groove therein and the second cover plate has a second groove therein. An electrically conductive coil is present within at least one of the first core assembly or the second core assembly. Between the diaphragm and the cover plates are soft magnetic armatures that are present within the first groove and within the second groove, the armatures being moveable within the grooves. Between the armatures and the diaphragm may be a spring support with an optional spacer.

Additional embodiments of micro speakers and methods of making them are also disclosed.

### BRIEF DESCRIPTION OF THE DRAWING

The invention may be more completely understood in consideration of the following detailed description of various embodiments of the invention in connection with the accompanying drawing, in which:

FIG. 1 is a perspective top view of a micro speaker according to this disclosure;

FIG. 2 is a perspective bottom view of the micro speaker of FIG. 1;

FIG. 3 is an exploded perspective view of the micro speaker of FIG. 1;

FIG. 4 is an exploded perspective view of a portion of the micro speaker of FIG. 1; and

FIG. 5A is a cross-sectional view of the micro speaker of FIG. 1; FIG. 5B is an enlargement of a portion of FIG. 5A.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present invention is directed to miniaturized, micro speakers that can be used in high performance speaker devices, such as hearing aids, headphones or earphone devices, and other small acoustical devices. At least one of the manufacturing steps of micro speaker devices of this invention can be done at a semiconductor wafer level, for example, built on a semiconductor chip using micro magnetic actuator technology (e.g., thin film or MEMS techniques). While the present invention is not so limited, an appreciation of various aspects of the invention will be gained through the discussion provided below.

In the following description, reference is made to the accompanying set of drawings that form a part hereof and in which are shown by way of illustration several specific embodiments. It is to be understood that other embodiments are contemplated and may be made without departing from the scope or spirit of the present invention. The following detailed description, therefore, is not to be taken in a limiting sense. A specific embodiment of a micro speaker according to this invention is illustrated in the figures as micro speaker 10.

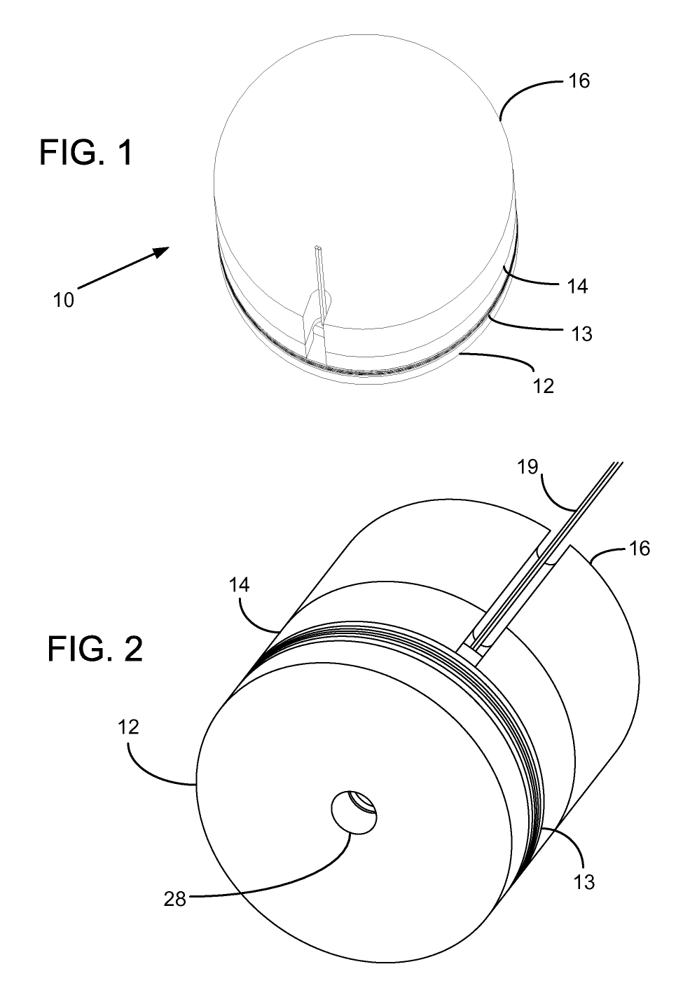

Micro speaker 10 has a first core assembly 12 and a second core assembly 14, in this embodiment, forming an overall cylindrical speaker 10. In FIGS. 1, 2 and 3, speaker 10 is oriented so that first core assembly 12 is the bottom core assembly and second core assembly 14 is the upper core assembly. It is understood that speaker 10 may be overturned so that second core assembly 14 is physically positioned below first core assembly 12 without departing from the scope of this disclosure, however, as used in this description, first core assembly 12 may be referred to as the lower or bottom core assembly and second core assembly 14 may be referred to as the upper or top core assembly. A back chamber 16 is positioned proximate second core assembly 14 opposite first core assembly 12. The design of back chamber 16 affects the operation of micro speaker 10, including the output power obtainable from micro speaker 10 for a specified input current.

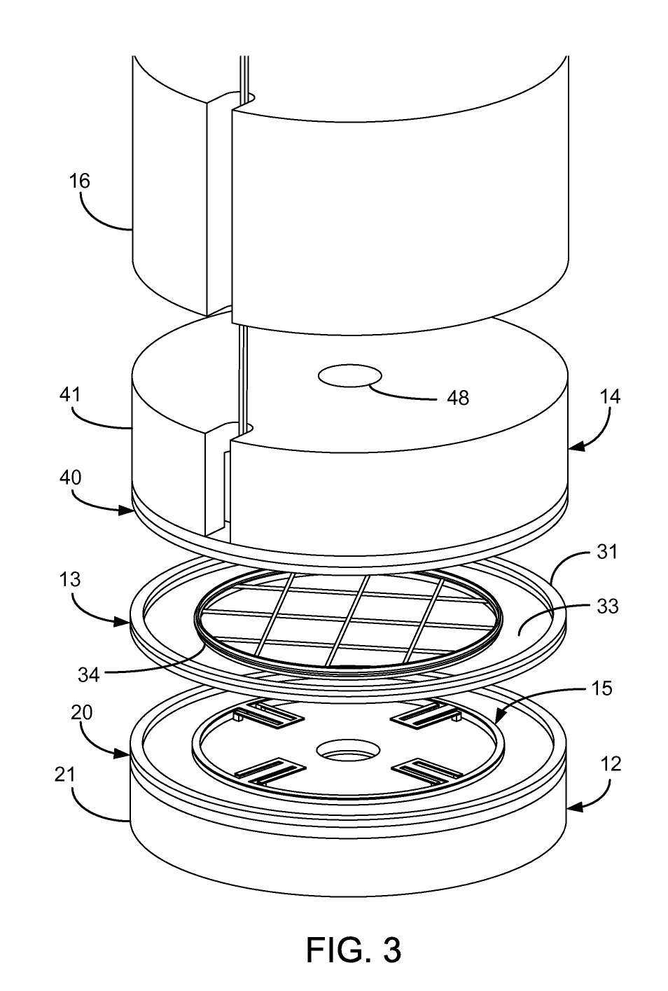

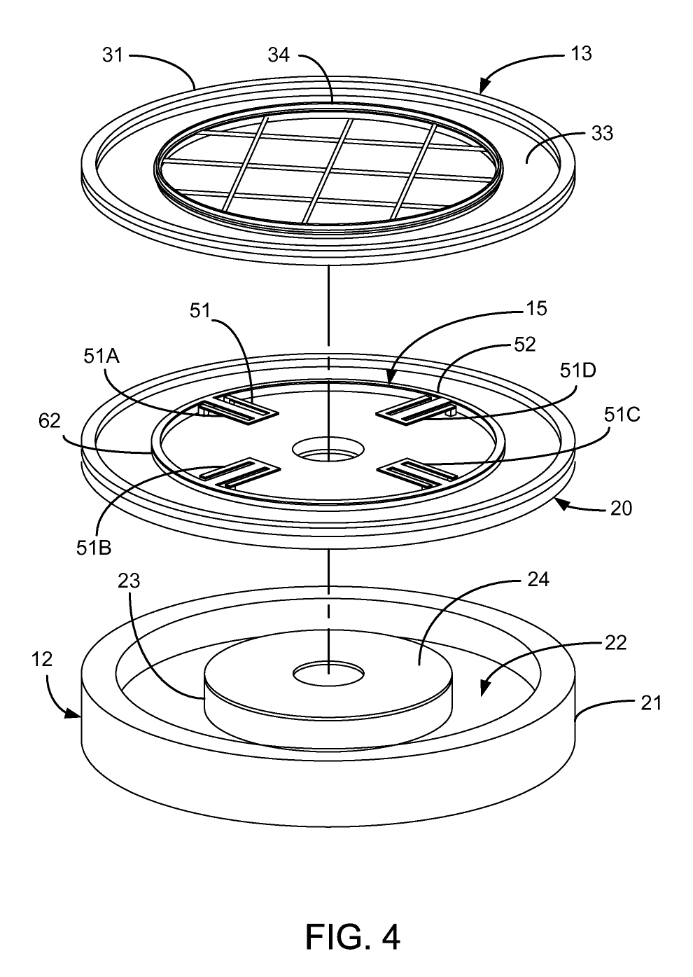

Best seen in FIGS. 3 and 4, first core assembly 12 has a housing 21 and an engageable cover plate 20, which together define an internal chamber 22 having a magnetic pole 23. In this embodiment, chamber 22 is annular, with central pole 23. In most embodiments, pole 23 is about 0.1 to 2 mm high. An electrically conductive coil (not illustrated in FIG. 4) may be present in chamber 22 around pole 23. The coil is formed from an electrically conducting material, typically metal. Examples of suitable metals for the coil include copper (Cu), aluminum (Al), silver (Ag) and gold (Au). The coil may be a single layer coil or multiple layer, and may have, for example, from one to 100 (one hundred) turns around pole 23. Generating the large force required to produce sound with speaker 10, while using as little power as possible, requires a large number of turns in the coil, as well as a large volume of conductive material to minimize the resistance.

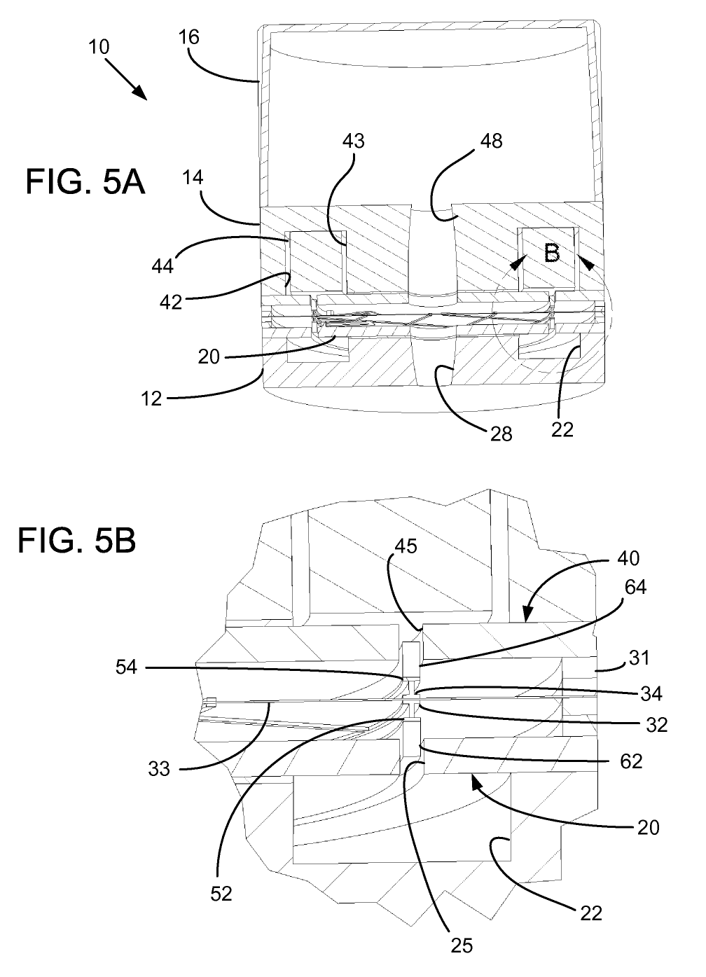

Within cover plate 20 is a groove 25 (see FIG. 5B) extending through cover plate 20. Second core assembly 14 is similar to first core 12, having a housing 41 and a cover plate 40 defining an internal chamber 42 (see FIG. 5A) having a pole 43 therein. An electrically conductive coil 44 may be present in internal chamber 42 of second core assembly 14 around pole 43, if not present in chamber 22 of core assembly 12. That is, a conductive coil is present in either first core assembly 12 or in second core assembly 14, and in some embodiments, is present in both assemblies 12, 14. In some embodiments, the conductive coil is present in second core assembly 14, due to its proximity to back chamber 16. Cover plate 40 has a groove 45 (see FIG. 5B) extending therethrough.

First core assembly 12 and second core assembly 14 may be formed from a soft magnetic material, that is, a material having a high magnetic permeability. Examples of soft magnetic materials include ferromagnetic materials such as nickel (Ni), iron (Fe), cobalt (Co), iron oxide (Fe₂O₃) and combinations thereof, such as nickel-iron (NiFe) or cobalt-iron (CoFe). Some soft magnetic materials have a high magnetic permeability and low coercivity and optionally having near zero magnetostriction. Examples of such materials include those materials known as permalloys, alloys of Ni—Fe. Cover plate 20, 40 of core assemblies 12, 14 may be formed from the same material as housings 21, 41.

Adjacent second core assembly 14 opposite first core assembly 12 may be back chamber 16 which may be formed from any suitable material, including a soft magnetic material. Back chamber 16 may be formed, for example, by electroforming over a permanent reusable mold. In some embodiments of a micro speaker, back chamber 16 is not present.

Returning to core assembly 12, pole 23 includes at least a layer of a hard or permanent magnetic material 24, the magnetization orientation of which does not change. Examples of permanent magnet materials include iron (Fe), chromium (Cr), cobalt (Co), nickel (Ni), platinum (Pt), vanadium (V), manganese (Mn), bismuth (Bi), and combinations thereof, such as cobalt-platinum (CoPt) or cobalt-nickel-phosphorous (CoNiP). Permanent magnetic material 24 may be made of bulk material or may be electrochemical deposited (e.g., plated) onto pole 23. Core assembly 14 includes a similar pole with permanent magnetic material. Present in first core assembly 12 is an outlet channel 28 (see FIGS. 2 and 5A), extending from the exterior of micro speaker 10 through housing 21 and cover plate 20. Present in second core assembly 14 is an outlet channel 48 (see FIGS. 3 and 5A), extending from back chamber 16 through housing 41 and cover plate 40. The function of outlet channels 28, 48 will be described below.

Between first core assembly 12 and second core assembly 14 is a diaphragm 13. During use of micro speaker 10, diaphragm 13 oscillates, toward and away from first core assembly 12 and from second core assembly 14, at a frequency to produce sound waves. Diaphragm 13 may be formed from any suitably flexible material, for example, polymeric materials such as polyurethane, polyester, polyethylene terephthalate, and polypropylene, or other rubber-like or flexible material. Operably connected to diaphragm 13 is circuitry 19 to provide input current to micro speaker 10 to oscillate diaphragm 13. Through different designs of diaphragm 13, the bandwidth of micro speaker 10 can be adjusted for a desired frequency range. The peak frequency (fₚₑₐₖ) for micro speaker 10 is dependent on the thickness of diaphragm 13, the width of diaphragm 13, and also the Young's Modulus of diaphragm 13. Thus, the physical design of diaphragm 13 affects the bandwidth and peak frequency of speaker 10.

Diaphragm 13 has an outer periphery 31 around a flexible membrane 33. Membrane 33 is fairly thin, typically about 1 to 100 micrometers thick, in order to oscillate and produce the desired frequency. Seen in FIG. 5B, positioned internal to outer periphery 31 proximate membrane 33 is a spacer structure 34 for spacing membrane 33 from cover plate 40. A spacer structure 32 is positioned on the opposite side of membrane 33, for spacing membrane 33 from cover plate 20. In this embodiment, spacers 32, 34 are annular structures with a lattice interior structure. Spacers 32, 34 may be formed from the same material as core assemblies 12, 14, such as a soft magnetic material, or may be formed from a non-magnetic material such as copper.

Positioned with groove 25 of cover plate 20 is a first armature 62 and positioned within groove 45 of cover plate 40 is a second armature 64; see FIG. 5B. Armatures 62, 64 are moveable within grooves 25, 45, respectively, so that as membrane 33 oscillates, armatures 62, 64 move vertically within grooves 25, 45 into and away from first core assembly 12 and second core assembly 14.

Seated proximate armature 62, between armature 62 and spacer 32, is a spring support 15, a portion of which contacts and supports membrane 33 during its oscillation. Spring support 15 preferably has a uniform or linear spring constant in each direction, toward and away from membrane 33. The particular spring support 15 illustrated in FIG. 4 has an annular frame 52 with at least one supporting spring 51, typically at least three supporting springs 51. In this embodiment, annular frame 52 is positioned between and contacts armature 62 and spacer 32 (see FIG. 5B). In the illustrated embodiment of FIG. 4, spring support 15 has four supporting springs 51A, 51B, 51C, 51D, in other embodiments, three supporting springs may be present. In this embodiment, each supporting spring 51 is a folded beam or supported-beam structure that provides a linear spring force over a large displacement range while resisting tilting and lateral motion. Supported-beam structure 51 extends from frame 52 at a first end. An inner beam structure surrounded by an outer support extends from the first end to a second end opposite the first end. At the second end, the inner beam structure is pivotally connected to the outer support. At the first end, the inner beam is pivotally or hingedly connected to frame 52 and the outer support is fixedly attached to frame 52. Such supported-beam structures provide a linear spring constant (towards and away from first cover plate 20) while resisting lateral motion. Other examples of supported structures that could be used for spring support 15 herein are described in Applicant's co-pending patent application Ser. No. 12/119,717 filed May 13, 2008. Spring support 15 may be formed from any suitably strong metal, such as nickel, iron, titanium, or various alloys.

On the other side of membrane 33, seated proximate armature 64, between armature 64 and spacer 34, is a second spring support, a portion of which contacts and supports membrane 33 during its oscillation. Seen in FIG. 5B, the second spring support has a annular frame 54 that is positioned between and contacts armature 64 and spacer 34.

From a top view (as in FIG. 1, for example), micro speaker 10 may be, for example, circular, oval, rectangular (e.g., square), although in most embodiments, speaker 10 is circular. When assembled, preferably, the outer periphery of each of the elements aligns to form a continuous outer surface. For example; a micro speaker with a circular top will be cylindrical in overall shape. As seen in FIG. 3, the exterior of housing 21 aligns with cover plate 20, which aligns with outer periphery 31 of diaphragm 13, which aligns with cover plate 40, which aligns with the exterior of housing 41, all which align with the exterior of back chamber 16. Neither armature structure 62, 64 nor spring supports 15 extend to the outer periphery of micro speaker 10, but rather have a smaller diameter than cover plate 20 and outer periphery 31 of diaphragm 13.

In most embodiments, micro speaker 10 and other micro speakers of this invention are no more than about 10 mm in their largest dimension, often no more than about 5 mm in their largest dimension. In other embodiments, micro speakers of this invention have a largest dimension of no more than about 3 mm, and sometimes, about 2 mm in largest dimension. In some embodiments, the micro speakers may have an aspect ratio (L/D) of about 1/1 to about 2/1.

In one particular example, a micro speaker with a desired maximum input current of 1 mA and a desired maximum input power of 1 mW, at maximum output power, has a diameter of about 3.5 mm and an overall length of about 3.65 mm (including first and second core assemblies and a back chamber). The coil in the first core assembly has an outer diameter of about 2.9 mm, an inner diameter of about 1.85 mm and is about 0.6 mm tall. The coil has about 1000 turns, with a maximum resistance of 1000 ohms. If the volume of the back chamber were doubled (i.e., thus creating an overall length for the micro speaker of about 5.5 mm), the output power from the micro speaker could be doubled. In another embodiment, if the volume of the back chamber were doubled, the input current required for the same output power could be halved.

Micro speaker 10 and others according to this invention have a variable reluctance motor with permanent magnet bias created by the moving soft magnetic armatures 62, 64 in and out of channels 25, 45. This configuration provides a large range of motion for diaphragm 13 that is more linear and free from disturbances than conventional ‘gap closing’ variable reluctance designs.

In use, an electrical current is applied to the coil, e.g., coil 44 in core assembly 14, via current input 19. The current will generate a magnetic field and polarize (e.g., charge) soft magnetic armatures 62, 64. Because the magnetic force is proportional to the square of the magnetic field, the permanent magnetic bias serves both to increase the force, by shifting the operating point to a higher field, and to linearize the force in relation to current, by operating at a bias field that is large compared to the variation in the field strength generated by the coil current. The balanced motor of micro speaker 10 uses two opposing structures (i.e., permanent magnet 25 in first core assembly 12 and the permanent magnet in second core assembly 14) so that the static force is balanced and the spring stiffness can be minimized. Applying current to the coil generates an imbalance in the fields between the two core assemblies 12, 14, generating a net output force on soft magnetic armatures 62, 64 that drives diaphragm 13, thereby creating waves (e.g., sound waves). Sound waves travel from oscillating membrane 33 through outlet channel 28 to the exterior of micro speaker 10 and through outlet channel 48 to back chamber 16.

As indicated above, all components of a micro speaker (e.g., micro speaker 10) except the coil (e.g., coil 44) could be fabricated at a wafer level, and also assembled to each other at the wafer level. The micro speaker could be, for example, built on a semiconductor chip using micro magnetic actuator technology (e.g., thin film or MEMS techniques). The back chamber (e.g., back chamber 16), if present, can be fabricated by electroforming over a permanent, reusable mold. The core assemblies (e.g., assemblies 12, 14) may be fabricated by either plating a material (for example, a soft magnetic material such as NiFe, CoFe, or similar) into a photoresist mold, or by etching and laminating several layers of foil (e.g., soft magnetic foil). The permanent magnets (e.g., magnet 24) can be fabricated by plating magnetic material (e.g., CoPt or CoNiP) onto the core assembly material. The armature (e.g., armature 62, 64) may be fabricated simultaneously with the cover plate (e.g., cover plate 20, 40) so that the armature is initially fully within the groove within the cover plate (e.g., groove 25, 45). The support spring (e.g., spring 15) can be bonded to the cover plate and armature prior to releasing the armature, thus eliminating the need to align the armatures to the grooves.

Thus, embodiments of the HIGH PERFORMANCE MICRO SPEAKER are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

The use of numerical identifiers, such as “first”, “second”, etc. in the claims that follow is for purposes of identification and providing antecedent basis. Unless content clearly dictates otherwise, it should not be implied that a numerical identifier refers to the number of such elements required to be present in a device, system or apparatus. For example, if a device includes a first widget, it should not be implied that a second widget is required in that device.

What is claimed is:

1. A micro speaker comprising:
a first core assembly comprising a first housing and a first cover plate, and a first permanent magnet within the first housing defining a first pole, the first cover plate having a first groove therein;
a second core assembly comprising a second housing and a second cover plate, and a second permanent magnet within the second housing defining a second pole, the second cover plate having a second groove therein;
an electrically conductive coil positioned around one of the first pole and the second pole;
a diaphragm positioned between the first cover plate and the second cover plate; and
a first armature present between the diaphragm and either the first cover plate and the second cover plate, at least a portion of the armature comprising a soft magnetic material present and moveable within either the first groove or the second groove.

2. The micro speaker of claim 1 further comprising a first spring support between the first armature and the diaphragm, the first spring support in operable contact with the diaphragm.

3. The micro speaker of claim 2 wherein the first spring support comprises a supporting spring with a folded beam suspension.

4. The micro speaker of claim 3 wherein the first spring support comprises four supporting springs with a folded beam suspension.

5. The micro speaker of claim 1 wherein at least one of the first permanent magnet and the second permanent magnet comprises CoPt or CoNiP.

6. The micro speaker of claim 1, wherein the first armature is present between the diaphragm and the first cover plate and is moveable within the first groove, the micro speaker further comprising a second armature present between the second cover plate and the diaphragm, at least a portion of the second armature comprising a soft magnetic material present and moveable within the second groove.

7. The micro speaker of claim 6 further comprising a second spring support between the second armature and the diaphragm, the second spring support in operable contact with the diaphragm.

8. The micro speaker of claim 7, further comprising a first spacer between the diaphragm and the first spring support, and a second spacer between the diaphragm and the second spring support.

9. The micro speaker of claim 6 wherein the first armature and the second armature comprise NiFe or CoFe.

10. The micro speaker of claim 1 wherein the coil comprises 100 to 10,000 turns around the first pole or the second pole.

11. The micro speaker of claim 1 further comprising a back chamber proximate the second core assembly opposite the diaphragm.

12. The micro speaker of claim 11 having a length of the first core assembly, the second core assembly and the back chamber no greater than about 5.5 mm.

13. The micro speaker of claim 1 wherein the diaphragm comprises polyurethane.

14. A micro speaker comprising:
a first core assembly comprising a first chamber defined by a first housing and a first cover plate, and a first permanent magnet within the first chamber, the first cover plate having a first groove therein;
a second core assembly comprising a second chamber defined by a second housing and a second cover plate, and a second permanent magnet within the second housing, the second cover plate having a second groove therein;
an electrically conductive coil positioned in one of the first chamber or the second chamber;
a diaphragm positioned between the first cover plate and the second cover plate;
a first armature present between the first cover plate and the diaphragm, at least a portion of the armature comprising a soft magnetic material present and moveable within the first groove;
a second armature present between the second cover plate and the diaphragm, at least a portion of the second armature comprising a soft magnetic material present and moveable within the second groove; and
a first spring support between the first armature and the diaphragm, the first spring support in operable contact with the diaphragm.

15. The micro speaker of claim 14 further comprising a second spring support between the second armature and the diaphragm, the second spring support in operable contact with the diaphragm.

16. The micro speaker of claim 15 wherein each of the first spring support and the second support comprises a supporting spring with a folded beam suspension.

17. The micro speaker of claim 16 wherein each of the first spring support and the second support comprises four supporting springs with a folded beam suspension.

18. The micro speaker of claim 14 further comprising a back chamber proximate the second core assembly opposite the diaphragm.

19. A micro speaker comprising:
a first core assembly having a first housing, a first permanent magnet within the first housing, and a first cover plate having a first groove therein;
a second core assembly having a second housing, a second permanent magnet within the second housing, and a second cover plate having a second groove therein;
an electrically conductive coil positioned in one of the first housing or the second housing;
a diaphragm positioned between the first cover plate and the second cover plate;
a first armature comprising soft magnetic material present within the first groove and moveable therein;
a second armature comprising soft magnetic material present within the second groove and moveable therein; and
a first spring support between the first armature and the diaphragm, the first spring support comprising four folded beam supporting springs in operable contact with the diaphragm.

20. The micro speaker of claim 19 further comprising a second spring support between the second armature and the diaphragm, the second spring support comprising four folded beam supporting springs in operable contact with the diaphragm.
